(19) United States
(12) Patent Application Publication
(10) Pub. No.: US 2005/0036857 A1
(43) Pub. Date: Feb. 17, 2005

(54) Automatic material handling system and stocker therefor

(76) Inventors: Hung-Wei Chen, Tainan City (TW); Yu-Yen Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/792,232

(22) Filed: Mar. 3, 2004

(30) Foreign Application Priority Data
Jul. 16, 2003 (TW) 92119362

(51) Int. Cl. B65G 1/00

(52) U.S. Cl. 414/279

(57) ABSTRACT

An automatic material handing system (AMHS). The AMHS comprises a rail, an overhead shuttle (OHS) and a stocker. The OHS moves on the rail. An in/out port (I/O port) is disposed in the stocker. The rail passes through the stocker and enters the I/O port. When the OHS is in the I/O port, a transport device places goods directly into the OHS.

### BACKGROUND OF THE INVENTION

1. Field of the Invention

The present invention relates to an automatic material handling system (AMHS), and in particular to an AMHS which uses space more flexibly.

2. Description of the Related Art

In conventional automatic material handing system (AMHS), goods are moved between stockers by an overhead shuttle (OHS). As shown in FIG. 1a, a conventional stocker 100 of the AMHS has a transport device 110, a plurality of cells 120 and an in/out port (I/O port) 130. Rollers 135 are provided at the I/O port 130. The transport device 110 moves the goods from the cells 120 to the I/O port 130. Then, the goods are moved to the OHS 140 by the rollers 135. The OHS 140 moves along a rail 142. As shown in FIG. 1b, the I/O port 130 comprises an I/O opening 132. The goods are moved to the OHS 140 through the I/O opening 132. In FIG. 1b, a single cell is shown to simplify the figure.

Because the rollers 135 produce vibration as they move the goods, moving heavy goods with conventional AMHS can be dangerous, especially for fragile goods. For example, glass plates moved by the rollers 135 may slip or break. The transmission speed of the rollers 135 is slow, increasing the waiting time of the OHS 142 for receiving goods. As well, the rail 142 is disposed by suspension. When goods are heavy, the rail 142 may break. Additionally, the rail 142 may be supported by floor-mounted supporting structures, which occupy floor space, decreasing available tool deployment.

### SUMMARY OF THE INVENTION

The present invention comprises a rail, an overhead shuttle (OHS) and a stocker. The OHS moves on the rail. An in/out port (I/O port) is disposed in the stocker. The rail passes through the stocker and enters the I/O port. When the OHS is in the I/O port, a transport device places goods directly into the OHS.

The present invention simplifies the I/O port by reducing the number of rollers, decreasing the cost of the AMHS, and solving vibration problems. As well, because the rail passes through the stocker, it's the structure is strengthened and secured. Placement of goods directly into the OHS by the transport device saves waiting time for the OHS, increasing transmission efficiency.

### BRIEF DESCRIPTION OF THE DRAWINGS

The present invention can be more fully understood by reading the subsequent detailed description and examples with references made to the accompanying drawings, wherein:

FIG. 1a is a top view of a conventional automatic material handing system (AMHS);

FIG. 1b is a perspective view of a conventional AMHS;

FIG. 2a is a top view of the first embodiment;

FIG. 2b is a top view of the second embodiment.

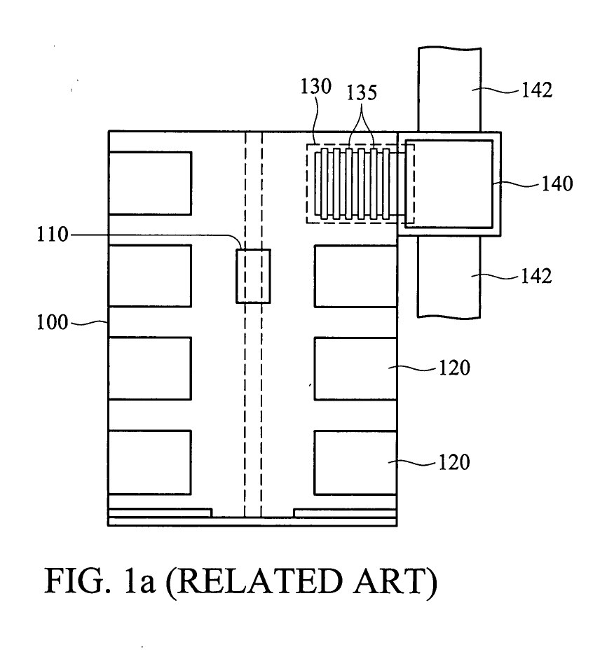

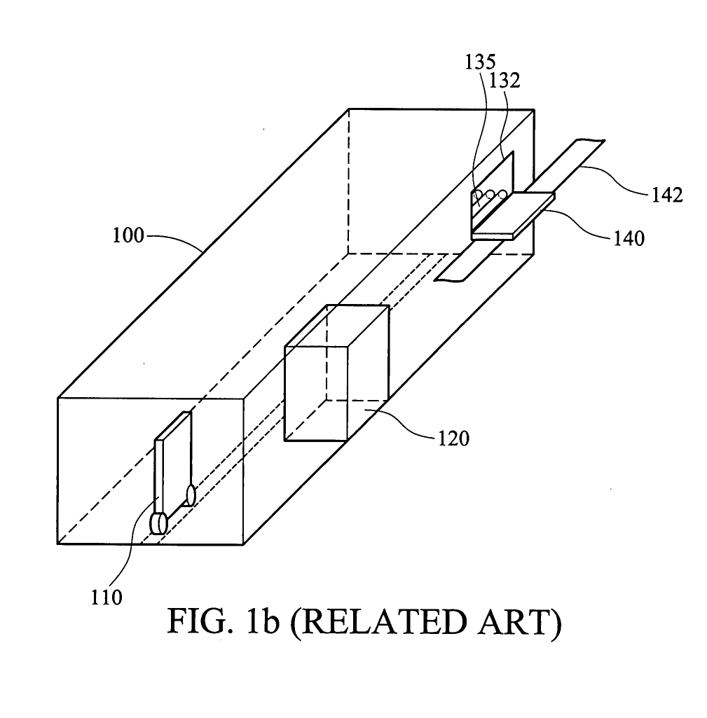

### DETAILED DESCRIPTION OF THE INVENTION

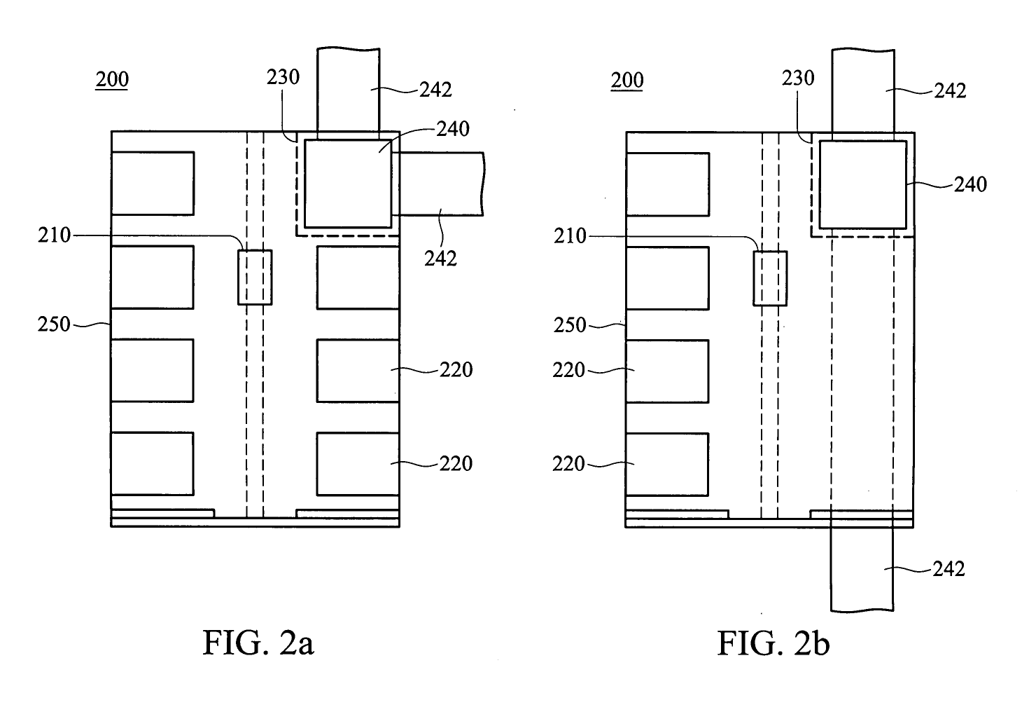

FIG. 2a shows the first embodiment of the present invention, which comprises a rail 242, an overhead shuttle (OHS) 240 and a stocker 200. The OHS 240 moves on the rail 242. The stocker 200 has a body 250 and an in/out port (I/O port) 230. The in/out port 230 is disposed in an upper portion of the body 250. The rail 242 passes through the body 250 and enters the I/O port 230 with an L-shaped portion. When the OHS 240 is in the I/O port 230, a transport device 210 places goods directly into the OHS 240.

When the goods are moved from the stocker 200 to the OHS 240, they are removed from cells 220 by the transport device 210, moved to the I/O port 230, and placed directly into the OHS 240. When the goods are moved from the OHS 240 into the stocker 200, the OHS 240 moves the goods to the I/O port 230, and the transport device 210 moves the goods to the cells 220.

FIG. 2b shows the second embodiment of the present invention, in which a straight rail 242 passes through the stocker 200. The second embodiment uses space flexibly. The first embodiment and the second embodiment can be used in the same AMHS to maximize use of space.

The present invention simplifies the I/O port 230 by reducing the number of rollers, decreasing the cost of the AMHS, and solving vibration problems. As well, because the rail 242 passes through the stocker 200, it's the structure is strengthened and secured. Placement of goods directly into the OHS 240 by the transport device 210 saves waiting time for the OHS 240, increasing transmission efficiency.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A stocker for an overhead shuttle traveling along a rail to transport goods therefrom and thereto, the stocker comprising:
a body;
a cell, disposed in the body;
an in/out port (I/O port), disposed in the body; and
a transport device, transporting the goods between the cell and the I/O port;
wherein the rail passes through the body and overlaps the I/O port.

2. The stocker as claimed in claim 1, wherein the I/O port is disposed in an upper portion of the body, and the rail passes through the upper portion of the body.

3. The stocker as claimed in claim 1, wherein the transport device removes the goods from the overhead shuttle or places the goods directly into the overhead shuttle when the overhead shuttle travels to the I/O port.

4. An automatic material handling system, comprising:
a rail;
an overhead shuttle, moved on the rail; and
a stocker, comprising an in/out port (I/O port) disposed in the stocker;
wherein the rail passes through the stocker and overlaps the I/O port.

5. The automatic material handling system as claimed in claim 4, wherein the stocker further comprises a cell and a transport device, the transport device transporting the goods between the cell and the I/O port.

6. The automatic material handling system as claimed in claim 5, wherein the transport device removes the goods from the overhead shuttle or places the goods directly into the overhead shuttle when the overhead shuttle travels to the I/O port.

7. The automatic material handling system as claimed in claim 4, wherein the I/O port is disposed in an upper portion of the stocker, and the rail passes through the upper portion of the stocker.
